(19) United States
(12) Patent Application Publication
(10) Pub. No.: US 2003/0117903 A1
(43) Pub. Date: Jun. 26, 2003

(54) Radio-controlled timepiece

(76) Inventors: Kenichi Nakajima, Chiba-shi (JP); Yoshimitsu Kurasawa, Chiba-shi (JP); Shigeo Suzuki, Chiba-shi (JP)

Correspondence Address: ADAMS & WILKS, 31st Floor, 50 Broadway, New York, NY, 10004, US

(21) Appl. No.: 10/306,694

(22) Filed: Nov. 27, 2002

(30) Foreign Application Priority Data
Nov. 29, 2001 (JP) 2001-364184

(51) Int. Cl. G04C 11/02

(52) U.S. Cl. 368/47

(57) ABSTRACT

To provide a radio-controlled timepiece capable of directing a standard time radio wave receiving antenna toward the suitable direction to a station easily and surely. The radio-controlled timepiece is to receive a standard time radio wave including time information in a standard time radio wave receiving unit and correct the time display based on the time information of the standard time radio wave received by the above receiving unit, and it includes a position calculating unit for detecting the direction of the station transmitting the standard time radio wave, based on a standard time radio wave signal received by the standard time radio wave receiving unit.

### BACKGROUND OF THE INVENTION

1. Field of the Invention

The present invention relates to a radio-controlled timepiece for adjusting the time by receiving a standard time radio wave including time information, and more particularly to a wristwatch typed radio-controlled timepiece.

2. Description of the Prior Art

There is known a radio-controlled timepiece for receiving a standard time radio wave obtained by amplitude modulation of a long carrier wave (for example, 40 KHz) with a code signal indicating time information and adjusting the display time according to the time information of the received radio wave. In Japan, since a station which is a sending source of this standard time radio wave is actually restricted to one place (the standard time radio wave transmitting station of 40 KHz in Fukushima prefecture, or the transmitting station of 60 KHz in Kyushu (since October, 2001), the transmissible direction of the standard time radio wave to be received is restricted and the intensity of the standard time radio wave is fairly weakened in a place far away from the station. While, a receiver of the standard time radio wave has a good directivity, but in an analog radio-controlled timepiece, the receiving sensitivity is various depending on the position of the timepiece, more specifically, the direction of the timepiece toward the station.

A general user of a radio-controlled timepiece doesn't have the accurate information about the direction of a station, the direction of an antenna of the timepiece, and the direction of good directivity. As a result, a user cannot direct the radio-controlled timepiece toward the proper direction to receive the standard time radio wave and he or she may fail to receive the standard time radio wave properly and adjust the time.

There is proposed a radio-controlled timepiece in which a pointer for indicating the receiving sensitivity (intensity) of the standard time-radio wave is provided and this is used for a user to search for a direction to get the greatest receiving sensitivity of the standard time radio wave while changing the direction of the timepiece variously before time adjustment.

In this kind of the radio-controlled timepiece, however, a user needs to repeat trials and errors in order to search for a direction to get the greatest receiving sensitivity, judge a proper direction, and direct the timepiece toward the above direction. Since the amplitude modulation has been performed on the standard time radio wave by the coded time information, there is a fear that the intensity of the received radio wave may fluctuate greatly in the average of a short time period. If the time for requiring the average value is set longer, though the fluctuation of the average intensity as for a specified direction becomes smaller, it takes longer time to know the direction dependency of the average intensity, which may make it difficult for a user to gaze after the direction dependency on a display of the pointer (average intensity).

Further, a diversity typed radio-controlled timepiece in which two receivers mutually extending in two right angled directions are used to detect the receiving intensity of the standard time radio wave and the receiver having detected the higher intensity of the two is adopted to detect the standard time radio wave, is disclosed and proposed in JP-A-2000-29814.

This radio-controlled timepiece, however, is not always positioned in a proper direction to receive the standard time radio wave, and there is a fear that a radio control is difficult in a place of weak radio wave because of a long distance from a station or circumstances thereabout. The JP-A-2000-29814 assumes a radio-controlled timepiece whose main body is comparatively large, thereby making the receiving antenna also large enough to enhance the sensitivity easily. Especially, in a wristwatch typed radio-controlled timepiece, it is difficult to enhance the sensitivity because the size thereof is much smaller than that of the radio-controlled table timepiece and there is a fear that the proposal of the diversity type in JP-A-2000-29814 is not enough to make the best use of a radio wave signal.

### SUMMARY OF THE INVENTION

In consideration to the above problem, an object of the invention is to provide a radio-controlled timepiece capable of properly directing its standard time radio wave receiving antenna toward a station at ease and for sure.

In order to solve the above object, the radio-controlled timepiece of the invention is a radio-controlled timepiece for receiving a standard time radio wave including time information by standard time radio wave receiving means and correcting time display based on the time information of the standard time radio wave received by the above receiving means, comprising direction detecting means for detecting a direction of a station which transmits the standard time radio wave based on a standard time radio wave signal received by the standard time radio wave receiving means.

Since the radio-controlled timepiece of the invention is provided with the direction detecting means for detecting a direction of a station which transmits the standard time radio wave based on a standard time radio wave signal (typically, the intensity of the standard time radio wave) received by the standard time radio wave receiving means, by directing the standard time radio wave receiving means of the radio-controlled timepiece toward the direction detected by the direction detecting means, the radio-controlled timepiece can receive the standard time radio wave actually in the optimum receiving state, to correct the time according to the above reception. Accordingly, even a wristwatch typed radio-controlled timepiece which is deteriorated in the receiving sensitivity because of size constraint can correct the time by using the standard time radio wave easily and surely, while directing the standard time radio wave receiving means toward the optimum direction to the station easily and surely.

Here, although the standard time radio wave signal that is the source of detecting a direction by the direction detecting means is typically the intensity of the standard time radio wave, it may be the amplitude of the standard time radio wave depending on a case. Since the standard time radio wave has been amplitude-modulated by the coded time information, as mentioned above, it may be required typically by the average of time to some degree or the time integration value (hereinafter, it is represented by “(time)average (value)”. The time is fixed depending on a desire and for example, about some seconds to ten seconds. If desired, however, it may be fixed shorter or longer. For example, in the special timing when year, month, or day may be changed or in the area or place where it turns out previously that the noise may easily occur, it may be fixed comparatively longer. In order to know the degree of noise, the average value of a predetermined period is required twice and more; when the degree of the difference is within a predetermined range, it is adopted as the average value to be required, while when the degree of the difference exceeds a predetermined range, the average value of the predetermined number of times may be regarded as a required average value. It is needless to say, that the difference may be similarly estimated as for the average value of the predetermined number of times and that the length for requiring the time average may be set longer so as to make the difference the predetermined range or less. In this case, the length of the time for requiring the time average may be fixed longer by the power of 2.

Since the standard time radio wave is received by a place at a distance from a sending station generally (in many cases), the standard time radio wave in the form of the plane wave is actually regarded to be received in the receiving means of the radio-controlled timepiece, and typically, in the receiving antenna of the standard time radio wave receiver that is a bar antenna formed by winding a coil around a bar elastic magnetic body, the direction in correspondence with the extending direction of the bar (bar body) becomes the direction of the maximum receiving sensitivity of the magnetic component of the standard time radio wave in the form of a traverse wave. Accordingly, the direction of the position of the sending station from view of the position of the radio-controlled timepiece is at right angles to the extending direction of the bar antenna. Namely, in this specification, the description “direct the standard time radio wave receiving means of the radio-controlled timepiece toward the direction detected by the direction detecting means” means that the standard time radio wave receiving means is directed toward the optimum direction to detect the time fluctuation of the magnetic component at right angles to the sending station.

In order to direct the standard time radio wave receiving means of the radio-controlled timepiece toward the direction detected by the direction detecting means, the direction of the case itself of the radio-controlled timepiece may be changed (typically, with the case of the timepiece horizontally held, it is rotated around the center), or the direction of the standard time radio wave receiving means within the radio-controlled timepiece may be changed, with the case of the radio-controlled timepiece remaining as it is.

In the former case, typically, the standard time radio wave receiving means includes a pair of standard time radio wave receivers of different directivity, and the direction detecting means includes a direction deciding unit for deciding the direction of the station which transmits the standard time radio wave based on intensities of the standard time radio waves received by the pair of the standard time radio wave receivers and pointer displaying means for visibly displaying a direction where a case is to be directed in correspondence with the direction decided by the direction deciding unit.

In this case, a user may direct the case of the radio-controlled timepiece toward the direction indicated by the pointer displaying means. When the pointer displaying means is designed to point the direction of a station, as mentioned above, the case of the radio-controlled timepiece is turned or moved so as to direct a longitudinal direction of the receiving antenna (typically, the bar antenna) forming the standard time radio wave receiving means within the radio-controlled timepiece at right angles to the direction of the station. When the pointer displaying means is designed to direct the direction deviated from the direction of the station by a predetermined angle (for example, the direction deviated by 45°, namely, the direction in correspondence with the direction of the magnetic component of the standard time radio wave), the case of the radio-controlled timepiece is rotated so as to be deviated from the direction of the station by a predetermined angle.

When a pair of the standard time radio wave receivers forming the standard time radio wave receiving means is formed by a pair of bar antennas actually having the same quality, which are mutually disposed at right angles, the bar antennas are respectively arranged to extend in the direction corresponding to the twelve o'clock position on the timepiece and in the direction corresponding to the position deviated from the twelve o'clock position by 90° (right angled). In this case, when the station stands in the twelve o'clock position on the timepiece, one of the pair of the standard time radio wave receivers forming the standard time radio wave receiving means (that one arranged at the position deviated by 90°) becomes maximum in sensitivity.

While, in the latter case, the standard time radio wave receiving means is supported by the case of the timepiece in a rotatable way, and the direction detecting means includes a direction changing means for changing a direction of the standard time radio wave receiving means relative to the timepiece case, a direction deciding unit for deciding the optimum direction to get the maximum intensity of the standard time radio wave received by the standard time radio wave receiving means, and a direction-change controlling unit for controlling the direction changing means so as to direct the standard time radio wave receiving means to the optimum direction.

In this case, according to only a user's instruction of radio control while holding the case of the radio-controlled timepiece, the standard time radio wave receiving means can be actually directed toward the optimum direction so to receive the standard time radio wave.

In order to solve the above object,a radio-controlled timepiece comprising: a standard time radio wave receiver to receive a standard time radio wave including time information; a correcting time circuit to correct time display based on the time information of the standard time radio wave received by the receiver; and a direction detecting circuit to detect a direction of a station which transmits the standard time radio wave based on a standard time radio wave signal received by the standard time radio wave receiver.

Although the above-mentioned radio-controlled timepiece is suitable for a wristwatch type, it may be used for a table-timepiece type when the direction can be selected, for example, in a table timepiece and the like.

### BRIEF DESCRIPTION OF THE SEVERAL VIEWS OF THE DRAWINGS

A preferred form of the present invention is illustrated in the accompanying drawings in which:

FIG. 1 show a radio-controlled watch according to a preferred embodiment of the invention; FIG. 1A is its schematic explanatory view and FIG. 1B is a flow chart showing the radio controlled operation/movement by using the radio-controlled watch of FIG. 1A;

FIG. 2 is a schematic block diagram of the radio-controlled watch of FIGS. 1;

FIG. 3 show a radio-controlled watch according to another preferred embodiment of the invention; FIG. 3A is its schematic explanatory view and FIG. 3B is a flow chart showing the radio controlled operation/movement by using the radio-controlled watch of FIG. 3A; and

FIG. 4 is a schematic block diagram of the radio-controlled watch of FIG. 3.

### DETAILED DESCRIPTION OF THE PREFERRED EMBODIMENTS

Preferred modes for carrying out the invention will be described according to preferred embodiments shown in the accompanying drawings.

[Embodiments]

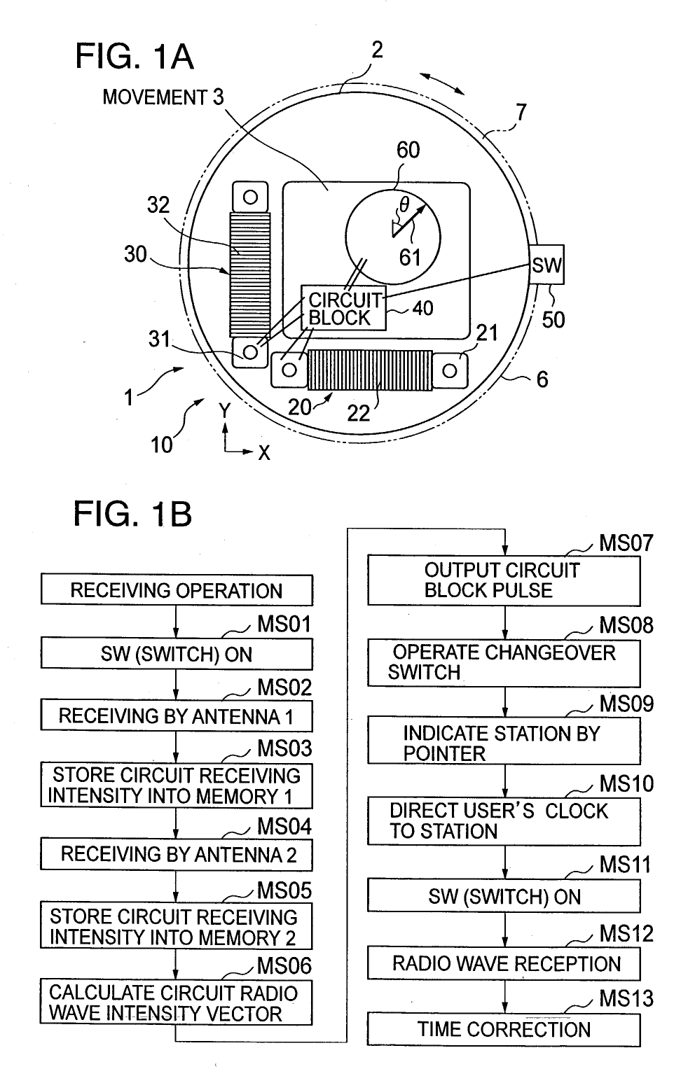

As illustrated in FIG. 1A, a radio-controlled timepiece 1 according to a preferred first embodiment of the invention is a watch such as a wristwatch or a fob watch, and a case 2 forming the main body of the watch includes a radio controlled mechanism 10 in addition to a movement 3 and a dial plate and display hands (not illustrated) for supporting the original timepiecework.

A standard time radio wave S is formed, for example, by a pulse modulation signal obtained through amplitude modulation of a 40 KHz carrier wave C by a code signal indicating the time information T, and the time information T includes the numeric information and day information indicating “minute, hour, the number of the total days having elapsed from January 1, the last two digits of the Christian year”. Of the above information, the numeric information is coded as BCD (binary-coded decimal) and it is superimposed on a carrier wave as an amplitude modulation pulse of about one second pulse width continued from a position marker of 00 second per minute.

Accordingly, when taking out the time information T from the standard time radio wave S, the low frequency component obtained by removing the carrier wave C through a filter is extracted as a time information pulse signal, while, when obtaining the information about the intensity of the received standard time radio wave S (typically, receiving intensity information), for example, a radio wave signal in the vicinity of 40 KHz frequency is extracted from the standard time radio wave S in order to detect the intensity of the carrier wave C.

The radio controlled mechanism 10 comprises first and second antennas 20 and 30 respectively extending in the direction X and the direction Y at right angles, a circuit block 40, and a changeover switch 60 within the case 2. In the below, assume that the direction Y indicates the twelve o'clock position on the dial plate of the watch 1 and that the direction X indicates the three o'clock position on the dial plate of the watch 1. Naturally, the direction Y may be arranged to indicate any other position than the twelve o'clock position if desired.

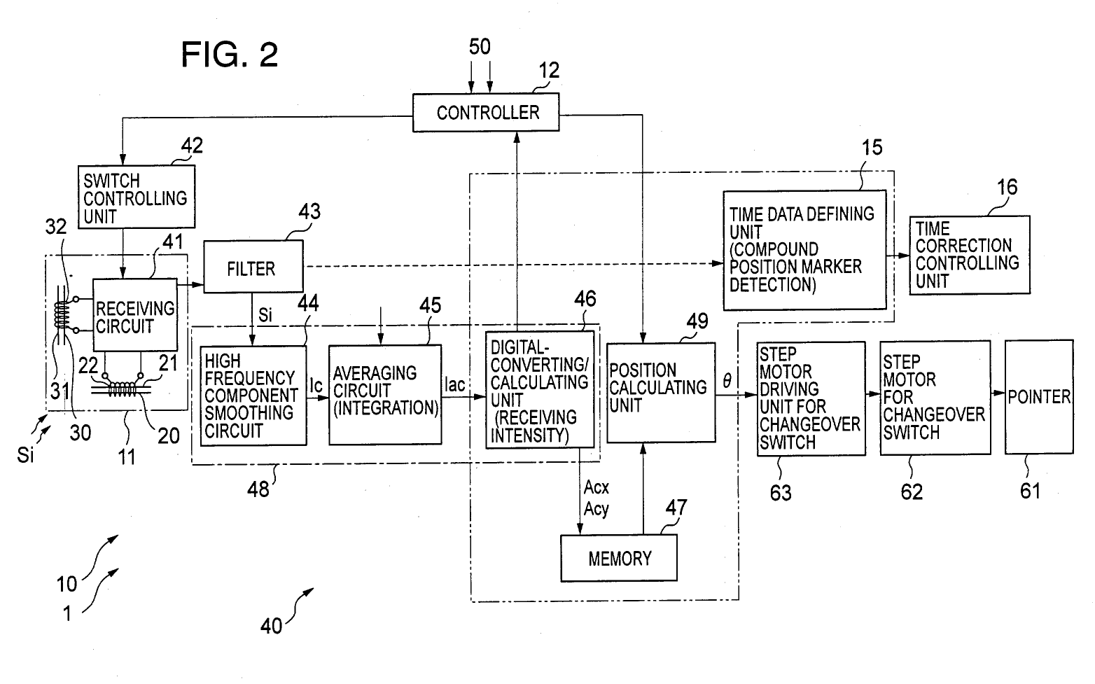

The antennas 20 and 30 are in the form of bar antennas including rod-like soft magnetic bodies 21 and 31 and receiving coils 22 and 32 respectively, and they are connected to the receiving circuit 41 so as to take out the time fluctuation of the magnetic component of the standard time radio wave S that is a transverse wave as voltage outputs at the both ends of the respective coils 22 and 32, as illustrated in FIG. 2. The antennas 20 and 30 and the receiving circuit 41 collaborate as receiving means 11. Connection of the antennas 20 and 30 and the receiving circuit 41 is switched by a switch controlling unit 42 under control of a main controlling unit or a controller 12.

A filter 43 is formed by, for example, a narrow bandwidth filter for taking out a signal Si in the vicinity of 40 KHz in order to exclude noises, and a signal of the carrier wave C of the standard time radio wave S is supplied to a high frequency component smoothing circuit 44, where a signal Ic indicating the intensity of the carrier wave C of the standard time radio wave S can be obtained (where, assuming that the amplitude modulation is performed actually at some Hz or less, since a difference between the sum frequency of the frequency of the carrier wave and the frequency of the amplitude modulation component and the difference frequency therebetween is smaller than the frequency of the carrier wave, the both frequencies are supplied to the smoothing circuit 44 and the signal Ic indicating the intensity of the carrier wave C actually agrees with a signal Is indicating the intensity of the standard time radio wave S). The reference numeral 45 indicates an integrator for performing averaging processing, which reduces the influence of noise, for example, by adopting the average value Iac (here, integration value) for some seconds. This average value Iac is converted into digital (A/D conversion) by a digital-converting/calculating unit 46, and thereafter, it is stored in the respective areas of a memory 47 as the carrier wave amplitudes Acx and Acy corresponding to the respective directions of the antennas 20 and 30.

An amplitude detecting unit 48 of the carrier wave C formed by the high frequency component smoothing circuit 44, the integrator 45, and the digital-converting/calculating unit 46 may be replaced with any other circuit. For example, after detecting the intensity of the carrier wave C (the square of the amplitude) or the standard time radio wave Si, the amplitude may be required. Alternatively, the output Si of the filter 43 maybe taken in by a sampling circuit for sampling the frequency of the carrier wave (the sum frequency of the carrier wave and the amplitude modulation wave and the difference frequency therebetween) at a desired frequency of random timing, the above processing may be performed during a period of some seconds to some tens of seconds, and the absolute values of the sampling values may be averaged, thereby requiring the value in proportion to the amplitudes Acx and Acy of the carrier wave C.

A position calculating unit 49 requires the transmissible direction θ of the standard time radio wave S from the amplitudes Acx and Acy in the directions X and Y as θ=arctan (Acx/Acy) and gives a rotation angle signal θ to a driving unit 63 of a step motor 62 for the changeover switch 60 so as to direct a pointer 61 of the changeover switch 60 toward the direction θ. Thus, the pointer which was pointing the direction parallel to the twelve o'clock position on the watch 1, in short, a station direction display pointer 61 is clockwise rotated by the angle θ from the direction Y. As a result, the receiving antenna 20 which is to extend at right angles to the direction θ is directed to the optimum direction to the transmissible direction θ. Here, typically, the transmissible direction substantially agrees with the direction where a station stands. However, since the standard time radio wave which may be diffracted or reflected depending on the land features and the circumstances around the receiving position is received, naturally the transmissible direction captured by the receiving antennas 20 and 30 does not always agree with the direction of the station.

As mentioned above, the circuit block 40 is formed by, for example, the controller 12 and the elements 43 to 49. Naturally, the controller 12 and the elements 46, 49, 47 and the like may be formed by a microprocessor, a memory, or a relevant processing program which can share the other operation of the watch.

The reference numeral 50 indicates a push button switch pushed by a user, and a first press of the push button switch 50 shows the direction of a station by the pointer 61 of the changeover switch 60 and a re-press of the same switch 50 after the display gives a press signal of the switch 50 to the controller 12 so as to start a time correcting operation and a control by the controller 12.

In the time correcting operation according to the standard time radio wave S, the time information T superimposed on the carrier wave C is taken out and defined by a time data defining unit 15 through the filter, the display time is corrected based on the same information T, at a detecting time of the position marker of 00 second, under control of a time correction controlling unit 16, and the pointer of the watch which was stopped starts moving again simultaneously with the detection of the standard time radio wave S.

A radio-control operation according to the above-mentioned constituted radio-controlled watch 1 will be described in sequence with reference to FIG. 1B.

In receiving the standard time radio wave S, a user horizontally holds, for example, the radio-controlled watch 1 with both hands. At this time, typically, in a state of ordinarily looking at a watch, the six o'clock position is on the, side facing a user and the twelve o'clock position is on the opposite side. While holding the radio-control watch 1 in this way, a user pushes the press button switch 50 to turn on (ON) the watch (Step MS01 of FIG. 1B). According to this, the initial setting of the radio controlled mechanism 10 is performed. This initial setting includes, for example, the setting of the pointer 61 at the initial position (the twelve o'clock position of the watch 1, namely the position of θ=0° in this example) by driving the step motor 62 through a step motor driving unit 63 for changeover switch.

A first press of the push button switch 50 produces a position detecting instruction from the main controlling unit or the controller 12 to the switch controlling unit 42, the switch controlling unit 42 connects the receiving circuit 41 to one antenna 20 (for example, in the direction X), and the X direction antenna 20 receives the standard time radio wave S (Step MS02).

The magnetic fluctuation of the standard time radio wave S detected by the antenna 20 in collaboration with the receiving circuit 41 is supplied to the standard time radio wave amplitude detecting unit or the carrier wave amplitude detecting unit 48 through the filter 43, and the amplitude detecting unit 48 requires the amplitude Acx in the direction X of the carrier wave C and stores it in a predetermined area of the memory 47 (Step MS03).

When finishing the measurement of the X direction amplitude Acx, the finish information is supplied from the amplitude detecting unit 48 to the controller 12, the switch controlling unit 42 connects the receiving circuit 41 to the other antenna 30 (for example, in the direction Y) under control of the controller 12, the Y direction antenna 30 receives the standard time radio wave S (Step MS04), and the amplitude detecting unit 38 requires the amplitude Acy of the direction Y of the carrier wave C and stores it in a predetermined area of the memory 47 (Step MS05).

Under control of the controller 12, the position calculating unit 49 requires the transmissible angle θ of the standard time radio wave S from the amplitudes Acx and Acy of the carrier wave C (Step MS06). According to the position data θ, a driving pulse is supplied from the step motor driving unit 63 to the step motor 62 for changeover switch (Step MS07), a rotor of the step motor 62 for changeover switch is rotated by the predetermined angle θ (Step MS08), and the display hand or pointer 61 is directed to the position of the station (MS09)

Next, a user rotates the radio-controlled watch 1 horizontally, so that the twelve o'clock position (Y direction) can agree with the direction θ of this pointer 61 (Step MS10). According to this rotation, the extending direction of the X direction antenna 20 results in the position at right angles to the direction θ which the pointer 61 was pointing. Here, a user doesn't need to be conscious of the direction of the X direction antenna 20 but only needs to adjust the twelve o'clock position to the direction pointed by the pointer 61. After adjusting the twelve o'clock position of the watch 1, a user re-presses the push button switch 50 (MS11). According to the second press of the switch 50, the controller 12 supplies the fluctuation signal of the magnetic component of the standard time radio wave S received by the receiving means 11 including the X direction antenna 20 and the receiving circuit 41, to the time data defining unit 15 through the filter 43, the data defining unit 15 decodes it to define the time (Step MS12), and according to the defined time, a time correction control is performed at a detecting timing of the position marker (Step MS13).

Although the intensity of the standard time radio wave has been detected once respectively in the direction X and the direction Y as the integration value of a predetermined period in the above-mentioned description, if desired, the integration period is set comparatively shorter as for the respective directions and the period integration value is required twice as for the respective directions. When a difference between the two values is within a predetermined range (ratio), one value or the average may be adopted as the period integration value. In this case, when the difference between the two period integration values exceeds the predetermined range (ratio), the integration period may be set some times longer and measurement of the period integration value may be repeated.

Although the above description has been made in a case of first receiving a signal by the X direction antenna and thereafter receiving a signal by the Y direction antenna, receiving by the Y direction antenna may be performed at first and thereafter receiving by the X direction antenna may be performed.

Instead of connecting the receiving circuit 41 selectively to the receiving coil 20 or 30 by the switching control unit 42, two series of the receiving circuit 41 and the following amplitude detecting unit 48 may be provided in order to simultaneously detect the intensity of the standard time radio wave signal in the direction X and the direction Y. This case can compensate for the influence of noises easily.

Although the above-mentioned description has been made in a case of adjusting the direction of the watch main body or the case 2 to the direction θ pointed by the pointer 61, a relatively rotatable ring 6 may be attached to the body 2, as illustrated in a supposed line in FIG. 1A, the ring 6 may be rotated so that a maker 7 attached to the ring 6 can agree with the direction of the pointer 61, after the pointer 61 defines the direction of the angle θ, and then, the watch main body 2 may be rotated and the direction of the watch main body 2 may be changed so that the twelve o'clock position of the watch main body 12 can agree with the marker 7 of the ring 6 in a state of holding the ring 6.

As far as it is possible to receive the standard time radio wave by adjusting the directivity of the standard time radio wave receiver to the respective directions mutually crossing (typically, crossing at right angles) and to determine the direction of a station, one standard time radio wave receiver may be used while changing the direction of the same standard time radio wave receiver, instead of using a pair of standard time radio wave receivers.

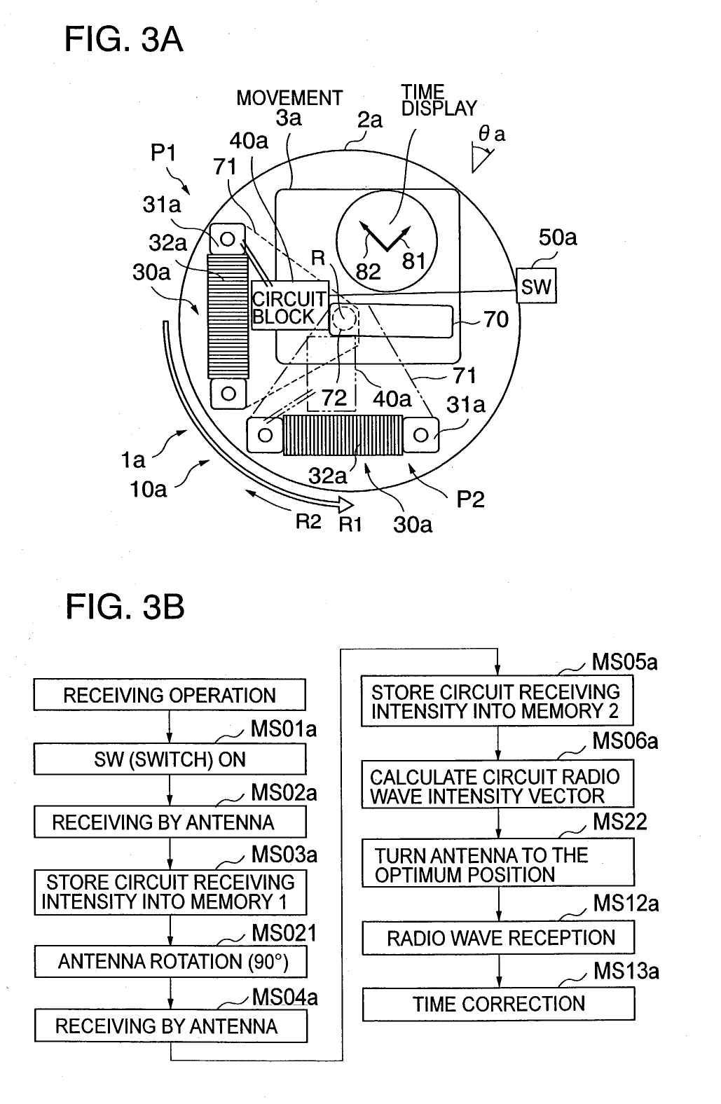

In the radio-controlled watch 1a of a second embodiment, as illustrated in FIG. 3, the mark “a” is attached to the same part or element as that of the radio-controlled watch 1 shown in FIG. 1. The radio-controlled watch 1a is provided with a bar antenna 30a for receiving the standard time radio wave which is supported in a rotatable way by the main body 2a of the watch 1a around the central axis line R, instead of a pair of antennas 20 and 30 in the direction X and the direction Y (since the antenna 30 has the same structure as that of the antenna 20, the antenna 30a may be indicated as the mark 20a. In FIG. 3A, however, a movable antenna is shown by the solid line in the same position as that of the antenna 30 of FIG. 1A, and therefore the reference mark is defined as 30a). The receiving antenna 30a is connected to, for example, a rotational axis 72 through an arm portion 71 and the rotational axis 72 can be rotated around the central axis line R by a step motor 70 for changing the direction of antenna, in R1 and R2 directions. A mechanism or structure for rotating the antenna 30a around the central axis line R may be replaced with any other one, instead of a combination of the motor 70, the axis 72, and the arm 71.

As illustrated in FIG. 3A, when the antenna 30a is in a first position corresponding to the direction Y or in the initial position P1, it moves in the same way as the antenna 30 of the radio-controlled watch 1, and when it is in the second position P2 corresponding to the direction X, it moves in the same way as the antenna 20 of the radio-controlled watch 1.

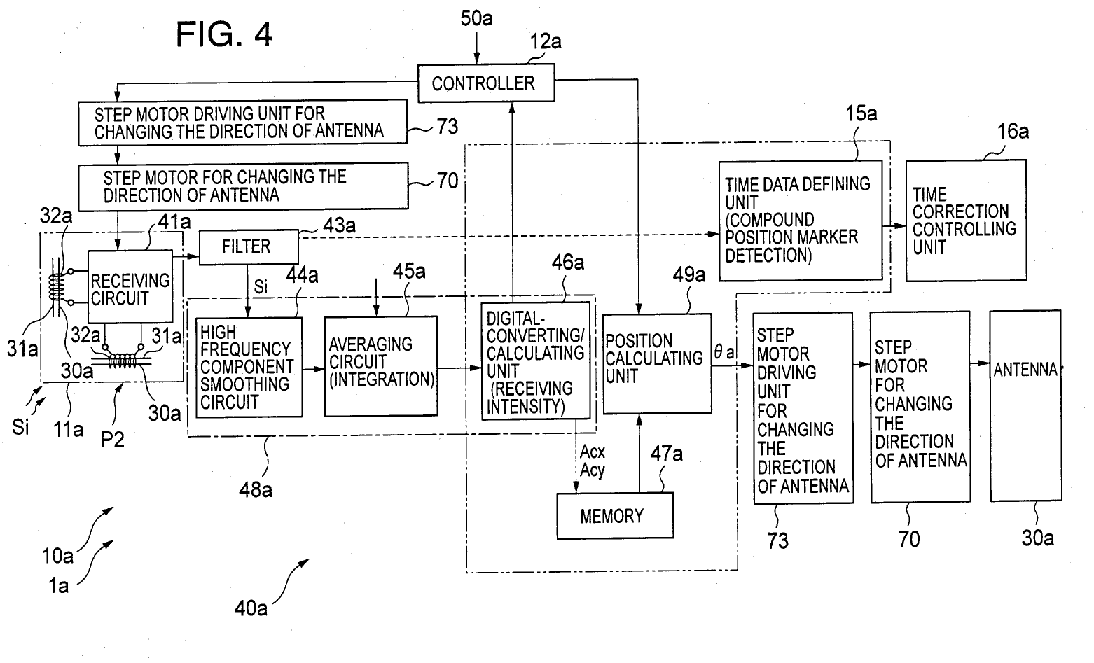

As illustrated in FIG. 4, a function block diagram of this radio-controlled watch 1a becomes the same as the function block diagram (FIG. 2) of the radio-controlled watch 1, except that a rotation series 70 to 73 of the receiving antenna 30a is provided there, instead of the rotation series 61 to 63 of the changeover switch 60 and the switch controlling unit 42. An operation step for the radio-controlled watch 1a is as shown in FIG. 3B.

Namely, in reply to the press of the push button switch 50a (Step MS01a), the standard time radio wave S is received by the antenna 30a standing in the initial position of the direction Y (Step MS02a), and the amplitude Acy of the Y direction magnetic component of the standard time radio wave is required by the circuit block 40a including the filter 43a and the amplitude detecting unit 48a (FIG. 4) and stored, in the memory (Step MS03a).

Upon completion of the storing step MS03a, the motor 70 for changing the direction of antenna is driven under control of the controller 12a having received the completion signal, so as to rotate the antenna 30a, for example, by 90° in the R1 direction, hence to be positioned at the P2 position in the direction X shown by the dotted line in FIG. 3A (Step MS20). This antenna rotation step MS21 corresponds to the transition from the storing step MS03 of the standard time radio wave receiving intensity data by one antenna 20 to the receiving step MS04 of the standard time radio wave by the other antenna 30 in FIG. 1B.

Upon completion of the 90° rotation of the antenna 30a, the standard time radio wave S is received by the antenna 30a positioned at the position P2 (Step MS04a), similarly to Steps MS04 to MS06, the amplitude Acy of the X direction magnetic component of the standard time radio wave S is required by the circuit block 40a and stored in the memory 47a (Step MS05a), and further the direction θa where the intensity of the standard time radio wave becomes maximum is required (Step MS06a).

Next, the direction where the receiving sensitivity of the antenna 30a becomes maximum is directed to the direction θa where the intensity of the standard time radio wave S becomes maximum (MS22), instead of rotating the pointer (Steps MS08 to MS09) and a user's directing the watch to the station (MS10). According to this, the antenna 30a which detects the temporal fluctuation of the magnetic component of the standard time radio wave S that is a traverse wave results in standing in the maximum sensitive position where its extending direction faces the direction of a station at right angles. This direction change of the antenna 30a corresponds to the rotation of the watch 1 (direction change) by a user in Step MS10, and the step motor 70 for changing the direction of antenna is driven according to the direction data θa, so as to rotate the antenna 30a by the angle θa° from the position P2 shown by the dotted line in FIG. 3A in the clockwise direction R2, hence to change the direction.

When the antenna 30a stands in the optimum direction, the standard time radio wave S is received (Step MS12a) under control of the controller 12a to detect the time data, and according to the detected time data, the time to be displayed with the display hands 81 and 82 and the like on the radio-controlled watch 1a is corrected (Step MS13a). The display hands 81 and 82 are shown in FIG. 3A, while they are not shown in FIG. 1A. This is not intentional but only for convenience in showing, and also in the radio-controlled watch 1 of FIG. 1A, the corrected time can be displayed in the same way. Although the display hands 81 and 82 are shown in a smaller size than the main body of the watch 2a for convenience's sake, in FIG. 3A, the display hands 81 and 82 are typically to be displayed on the dial plate of the substantially same size as the main body of the watch 2a.

In this radio-controlled watch 1a, in a state of, for example, horizontally holding or putting the watch 1a, only a user's push of the push button switch 50a moves the antenna 30a between the two right angle directions and automatically determines the direction θa where the intensity of the standard time radio wave S becomes maximum from the respective receiving intensities of the standard time radio wave S when the antenna 30a stands in the respective two directions (more specifically, the corresponding amplitudes Acx and Acy), and the antenna 30a is directed toward the direction θa. Accordingly, even if the radio-controlled watch 1a is a small wristwatch and the sensitivity of a receiving system series is comparatively low because the receiving antenna 30a and the like are small in size, a possibility of properly capturing the standard time radio wave can be increased and a fear of failing in the time correction can be decreased to the minimum. Further, since the direction of the antenna 30a can be automatically adjusted, a user can save a trouble and load to correct the time, to the minimum.

What is claimed is:

1. A radio-controlled timepiece comprising:
standard time radio wave receiving means for receiving a standard time radio wave including time information;
correcting time means for correcting time display based on the time information of the standard time radio wave received by the receiving means; and
direction detecting means for detecting a direction of a station which transmits the standard time radio wave based on a standard time radio wave signal received by the standard time radio wave receiving means.

2. The radio-controlled timepiece as claimed in claim 1, wherein
the standard time radio wave receiving means includes a pair of standard time radio wave receivers of different directivity, and the direction detecting means includes a direction deciding unit for deciding the direction of the station which transmits the standard time radio wave based on intensities of the standard time radio waves received by the pair of the standard time radio wave receivers and pointer displaying means for visibly displaying a direction where a case is to be directed in correspondence with the direction decided by the direction deciding unit.

3. The radio-controlled timepiece as claimed in claim 1, wherein
the standard time radio wave receiving means is supported by the case of the timepiece in a rotatable way, and the direction detecting means includes a direction changing means for changing a direction of the standard time radio wave receiving means relative to the timepiece case, a direction deciding unit for deciding the optimum direction to get the maximum intensity of the standard time radio wave received by the standard time radio wave receiving means, and a direction-change controlling unit for controlling the direction changing means so as to direct the standard time radio wave receiving means to the optimum direction.

4. A radio-controlled timepiece comprising:
a standard time radio wave receiver to receive a standard time radio wave including time information;
a correcting time circuit to correct time display based on the time information of the standard time radio wave received by the receiver; and
a direction detecting circuit to detect a direction of a station which transmits the standard time radio wave based on a standard time radio wave signal received by the standard time radio wave receiver.
